(19) United States
(12) Patent Application Publication
(10) Pub. No.: US 2024/0360958 A1
(43) Pub. Date: Oct. 31, 2024

(54) GAS INJECTION DEVICE

(71) Applicant: Samsung Electronics Co., Ltd., Suwon-si (KR)

(72) Inventors: Hyunchul CHO, Suwon-si (KR); Jaehyo JEONG, Suwon-si (KR); Yonghwa CHOI, Suwon-si (KR); Taewook KANG, Suwon-si (KR)

(21) Appl. No.: 18/766,179

(22) Filed: Jul. 8, 2024

Related U.S. Application Data
(63) Continuation of application No. PCT/KR2023/000728, filed on Jan. 16, 2023.

(30) Foreign Application Priority Data
Feb. 9, 2022 (KR) 10-2022-0016970

(51) Int. Cl. F17C 7/00; F28F 99/00

(52) U.S. Cl. CPC F17C 7/00; F17C 2205/0311; F28F 99/00

(57) ABSTRACT

A gas injection device according to an example includes a support portion having a first sidewall extending at a first slope, a sealing cap including an elastic material and having a second sidewall extending at a second slope, and a pipe connection portion having a conduit shape including a through-hole extending in a first direction, the pipe connection portion having one end portion connected to one end portion of the sealing cap, wherein the first sidewall and the second sidewall are arranged to face each other, and a first inclination angle formed by the first direction and the first sidewall is greater than a second inclination angle formed by the first direction and the second sidewall.

### CROSS-REFERENCE TO RELATED APPLICATIONS

This application is a continuation of International Application No. PCT/KR2023/000728 designating the United States, filed on Jan. 16, 2023, in the Korean Intellectual Property Receiving Office and claiming priority to Korean Patent Application No. 10-2022-0016970, filed on Feb. 9, 2022, in the Korean Intellectual Property Office, the disclosures of each of which are incorporated by reference herein in their entireties.

### BACKGROUND

### Field

The disclosure relates to a gas injection device for supplying gas to a gas supply portion.

### Description of Related Art

A cooling cycle for heat exchange with surroundings may be used in cooling devices such as air conditioners or refrigerators. The cooling cycle may be configured by individually manufacturing a compressor, a condenser, an expansion device, and a heat exchanger, connecting each component to form a closed circuit through a refrigerant pipe, and then injecting a refrigerant therein.

In order to increase the cooling effect of the cooling cycle and prevent or reduce performance degradation, air should not be introduced into the cooling cycle. When air is introduced into the cooling cycle, there is a risk of internal oxidation due to moisture contained in the air. In addition, when air is introduced into the cooling cycle, it becomes difficult to condense and evaporate a refrigerant. Due to this, the compressor may be overloaded and the lifespan of the compensator may be shortened. Therefore, when the heat exchanger is manufactured, the inside of the heat exchanger is filled with inert gas, and then, the heat exchanger is distributed on the market.

In order to fill the heat exchanger with inert gas, an end portion of a tube of the heat exchanger may be covered with a sealing cap including rubber, and helium or nitrogen gas may be injected into the heat exchanger using a syringe-type gas injector with a needle. However, when gas is injected using the syringe-type gas injector, the sealing cap may be torn or damaged, causing inert gas filled inside the heat exchanger to leak to the outside.

### SUMMARY

Embodiments of the disclosure provide a gas injection device that is capable of preventing and/or reducing gas injected into a gas supply portion from leaking to the outside by compressing a sealing cap that seals one end portion of the gas supply portion.

Embodiments of the disclosure provide a gas injection device that is capable of ensuring design convenience by limiting a shape of a contact surface supported between a sealing cap and a support portion to prevent and/or reduce gas injected into a gas supply portion from leaking to the outside.

A gas injection device according to an example embodiment includes: a support having a first sidewall extending at a first slope, a sealing cap including an elastic material and having a second sidewall extending at a second slope, and a pipe connection portion comprising a connector including a conduit shape having a through-hole extending in a first direction, the pipe connection portion having one end portion connected to one end portion of the sealing cap, wherein the first sidewall and the second sidewall may be arranged to face each other, and a first inclination angle formed by the first direction and the first sidewall may be greater than a second inclination angle formed by the first direction and the second sidewall.

A difference between the first inclination angle and the second inclination angle may be greater than 0° and less than or equal to 15°.

The support may include a nut, and the pipe connection portion may include a nipple having one side capable of being fastened to the nut.

Based on the support portion and the pipe connection portion being fastened to each other and the pipe connection portion moving in the first direction with respect to the support, the sealing cap may be compressed between the support and the pipe connection portion.

The support may include a hollow extending in the first direction, and the other end portion of the sealing cap may be configured to pass through the hollow.

The gas injection device may further include a support cap arranged between the support and the sealing cap.

The support cap may include: a third sidewall arranged to face the first sidewall and extending at a third slope, and a fourth sidewall arranged to face the second sidewall and extending at a fourth slope.

A first inclination angle formed by the first direction and the first sidewall may be equal to a third inclination angle formed by the first direction and the third sidewall, and a fourth inclination angle formed by the first direction and the fourth sidewall may be greater than a second inclination angle formed by the first direction and the second sidewall.

A difference between the fourth inclination angle and the second inclination angle may be greater than 0° and less than or equal to 15°.

The support may include a hollow extending in the first direction, and one end portion of the support cap may be configured to pass through the hollow.

A gas injection device according to an example embodiment includes: a support portion comprising a support including a first sidewall having a curved shape extending with a first curvature, a sealing cap including an elastic material and including a second sidewall having a curved shape extending with a second slope, and a pipe connection portion comprising a connector including a conduit shape having a through-hole extending in a first direction, the pipe connection portion having one end portion connected to one end portion of the sealing cap, wherein the first sidewall and the second sidewall may be arranged to face each other, the first sidewall extending to have a first inclination angle with the first direction, the second sidewall having a curved surface extending to have a certain curvature in the first direction, and an inclined surface extending in a straight line between a first point at which the curved surface starts and a second point at which the curved surface ends may have a second-first inclination angle with the first direction, the first inclination angle being greater than the second-first inclination angle.

A difference between the first inclination angle and the second−1 inclination angle may be greater than 0° and less than or equal to 15°.

The support portion may include a nut, and the pipe connection portion may include a nipple having one side that is capable of being fastened to the nut.

Based on the support portion and the pipe connection portion being fastened to each other and the pipe connection portion moving in the first direction with respect to the support portion, the sealing cap may be compressed with respect to the support portion.

The support portion may include a hollow extending in the first direction, and the other end portion of the sealing cap may be configured to pass through the hollow.

The gas injection device may further include a support cap arranged between the support portion and the sealing cap.

The support cap may include: a third sidewall arranged to face the first sidewall and extending at a third slope, and a fourth sidewall arranged to face the second sidewall and extending at a fourth slope. The first inclination angle formed by the first direction and the first sidewall may be equal to a third inclination angle formed by the first direction and the third sidewall, and a fourth inclination angle formed by the first direction and the fourth sidewall may be greater than the second-first inclination angle formed by the first direction and the second sidewall.

A difference between the fourth inclination angle and the second-first inclination angle may be greater than 0° and less than or equal to 15°.

The support portion may include a hollow extending in the first direction, and one end portion of the support cap may be configured to pass through the hollow.

According to various example embodiments of the present disclosure, there is provided a gas injection device that is capable of preventing and/or reducing gas injected into a gas supply portion from leaking to the outside by compressing a sealing cap that seals one end portion of the gas supply portion.

In addition, according to various example embodiments of the present disclosure, design convenience of a manufacture may be improved by limiting a shape of a contact surface supported between a sealing cap and a support portion to prevent and/or reduce gas injected into a gas supply portion from leaking to the outside.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example heat exchanger to which a gas injection device is connected, according to various embodiments;

FIG. 2 is a perspective view illustrating an example gas supply device according to various embodiments;

FIG. 3 is an exploded perspective view of the gas supply device illustrated in FIG. 2 according to various embodiments;

FIG. 4A is a cross-sectional view of the gas supply device illustrated in FIG. 2 taken along line A-A′ according to various embodiments;

FIG. 4B is a cross-sectional view of a state in which a gas injection needle for gas injection passes through a sealing cap in FIG. 4A according to various embodiments;

FIG. 5A is an enlarged cross-sectional view of a portion illustrated in FIG. 4A according to various embodiments;

FIG. 5B is an enlarged cross-sectional view of the sealing cap illustrated in FIG. 4A according to various embodiments;

FIG. 6A is a perspective view of a gas supply device according to various embodiments;

FIG. 6B is an exploded perspective view of the gas supply device illustrated in FIG. 6A according to various embodiments;

FIG. 7 is a cross-sectional view of the gas supply device illustrated in FIG. 6A taken along line B-B′ according to various embodiments;

FIG. 8 is an enlarged cross-sectional view of a portion illustrated in FIG. 7 according to various embodiments;

FIG. 9 is a perspective view of a gas supply device according to various embodiments;

FIG. 10 is a cross-sectional view of the gas supply device illustrated in FIG. 9 taken along line C-C′ according to various embodiments;

FIG. 11 is an enlarged cross-sectional view of a portion illustrated in FIG. 10 according to various embodiments;

FIG. 12 is a perspective view of an example gas supply device according to various embodiments;

FIG. 13 is a cross-sectional view of the gas supply device illustrated in FIG. 12 taken along line D-D′ according to various embodiments; and

FIG. 14 is an enlarged cross-sectional view of a portion illustrated in FIG. 13 according to various embodiments.

### DETAILED DESCRIPTION

Hereinafter, various structures and operations of various example embodiments of the present disclosure will be described in greater detail with reference to the accompanying drawings.

The terms as used herein are briefly described and the present disclosure is described in greater detail.

As for the terms as used in the present disclosure, common terms that are currently widely used are selected as much as possible while taking into account the functions in the present disclosure. However, the terms may vary depending on the intention of those of ordinary skill in the art, precedents, the emergence of new technology, and the like. Also, in a specific case, there are also terms that may be arbitrarily selected. In this case, the meaning of the terms will be described in detail in the description of the present disclosure. Therefore, the terms as used in the present disclosure should be defined based on the meaning of the terms and the description throughout the present disclosure rather than simply the names of the terms.

Throughout the disclosure, the expression “a portion includes a certain element” may refer, for example, to a portion further including other elements rather than excludes other elements unless otherwise stated.

Terms such as “first, second,” etc. are used not in a restrictive sense but are used to distinguish one element from another.

Various example embodiments of the present disclosure will be described in greater detail with reference to the accompanying drawings. However, the present disclosure may be implemented in various different forms and is not limited to the various embodiments described herein. In order to clearly explain the present disclosure, parts irrelevant to the description may be omitted in the drawings and similar reference numerals denote similar parts throughout the disclosure.

On the other hand, the terms “upper side,” “lower side,” and “front-back direction” used in the following description are based on the drawings, and the shape and position of each element are not limited by these terms.

Hereinafter, various example embodiments according to the present disclosure are described in greater detail with reference to the accompanying drawings.

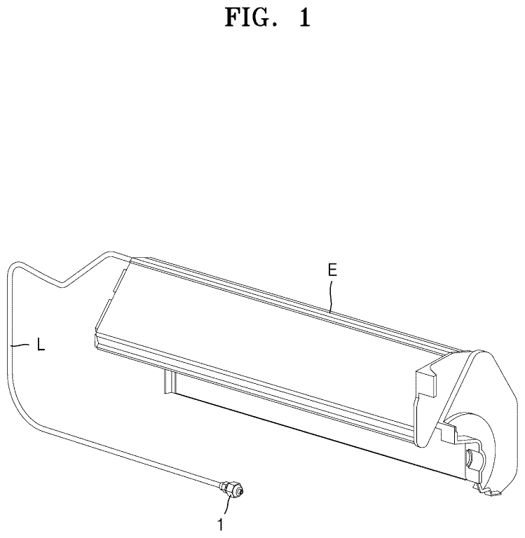

FIG. 1 is a perspective view illustrating an example heat exchanger to which a gas injection device is connected, according to various embodiments.

Referring to FIG. 1, a gas injection device 1 according to an example may be arranged at one end portion of a gas pipe L connected to a heat exchanger E. As an example, a high-pressure inert gas above atmospheric pressure may be injected into the heat exchanger E until a refrigerant circulates. Accordingly, air is prevented and/or reduced from flowing into the heat exchanger E, and internal oxidation of the heat exchanger E may be prevented and/or reduced.

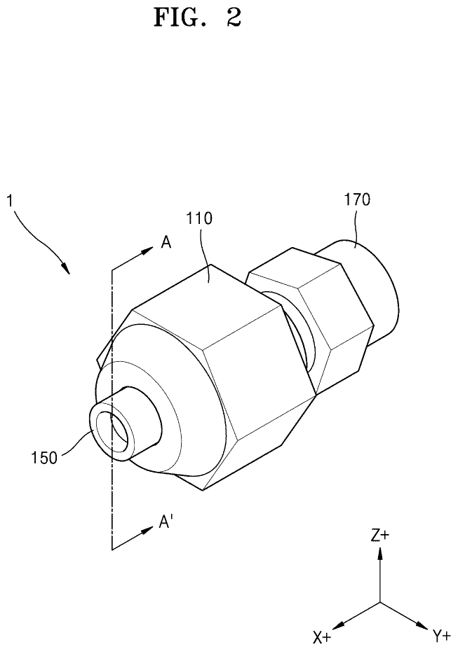

The injecting of the inert gas into the heat exchanger E is performed in a final process after the heat exchanger E is manufactured. As an example, in order to inject the inert gas into the heat exchanger E, the gas injection device 1 arranged at one end portion of the gas pipe L connected to the heat exchanger E may be used. After the inert gas is injected into the heat exchanger E, the gas injection device 1 has to be sealed from the outside so as to prevent and/or reduce the inert gas from leaking from the heat exchanger E. The gas injection device 1 according to an example may include a sealing cap (see 150 of FIG. 2) including an elastic material so as to prevent and/or reduce the high-pressure inert gas injected thereinto from leaking to the outside after the inert gas is injected. Hereinafter, the gas injection device 1 including the sealing cap (see 150 of FIG. 2) so as to prevent and/or reduce the inert gas injected into the heat exchanger E, which is a gas supply portion, from leaking to the outside is described in greater detail. In the example described above, a case where an object to which gas is supplied using the gas injection device 1 is the heat exchanger E, but the present disclosure is not limited thereto. It will be apparent that the gas injection device 1 according to an example may be used in any gas supply portion that is connected to the gas injection device 1 to receive gas and has to prevent and/or reduce the supplied gas from leaking.

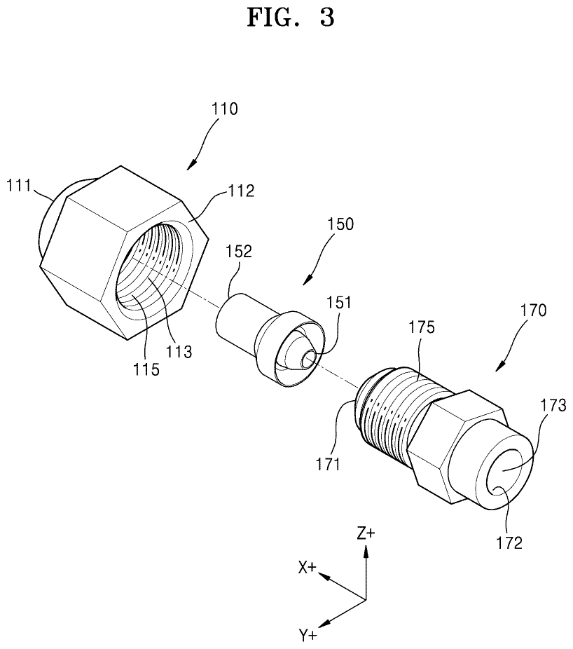

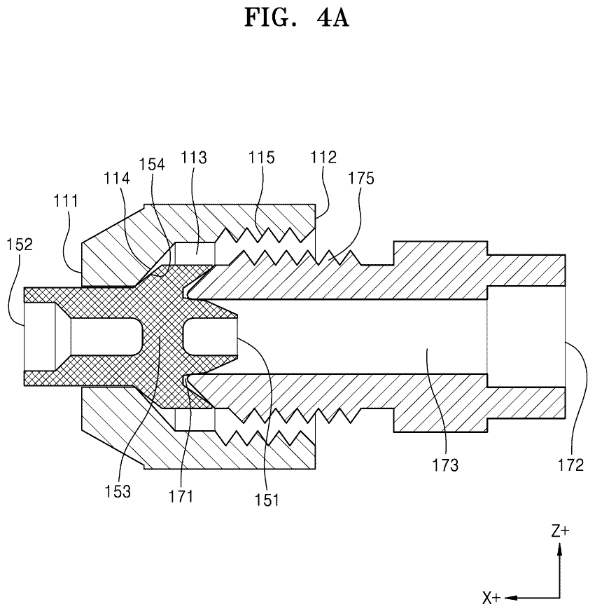

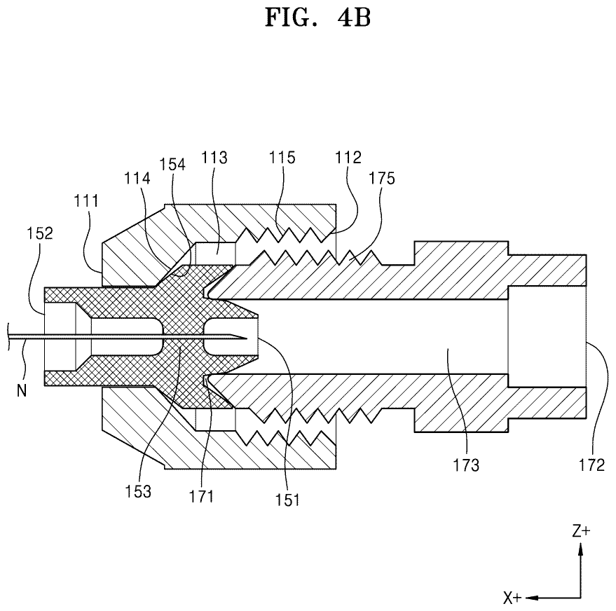

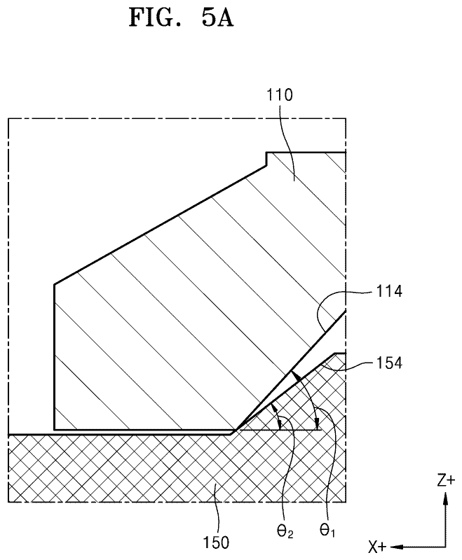

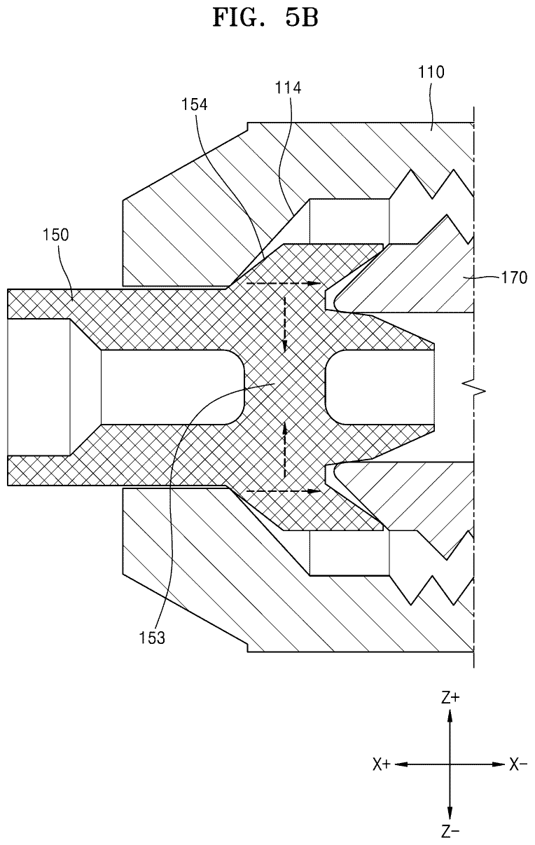

FIG. 2 is a perspective view of a gas supply device according to various embodiments. FIG. 3 is an exploded perspective view of the gas supply device illustrated in FIG. 2 according to various embodiments. FIG. 4A is a cross-sectional view of the gas supply device illustrated in FIG. 2 taken along line A-A′ according to various embodiments. FIG. 4B is a cross-sectional view of a state in which a gas injection needle for gas injection passes through a sealing cap in FIG. 4A according to various embodiments. FIG. 5A is an enlarged cross-sectional view of a portion illustrated in FIG. 4A according to various embodiments. FIG. 5B is an enlarged cross-sectional view of the sealing cap illustrated in FIG. 4A according to various embodiments.

Referring to FIGS. 2, 3, 4A and 4B (which may be referred to as FIGS. 2 to 4B), a gas injection device 1 according to an example may include a support portion 110, a sealing cap 150 arranged to prevent and/or reduce supplied gas from leaking, and a pipe connection portion 170 having one end portion connected to the sealing cap 150 and the other end portion 172 connected to the gas pipe (see L of FIG. 1).

The support portion 110 includes a support member that supports the sealing cap 150. The support portion 110 according to an example may include a hollow 113 extending in a first direction (X+). As an example, the hollow 113 may be provided in a penetrating shape starting from one end portion 111 of the support portion 110 and extending up to the other end portion 112 thereof. The sealing cap 150, which will be described in greater detail below, may be arranged such that the other end portion 152 of the sealing cap 150 enters the other end portion 112 of the support portion 110 and pass through one end portion 111 of the support portion 110. Accordingly, the sealing cap 150 may be supported by the support portion 110.

According to an example, the support portion 110 may include a first sidewall 114 extending at a first slope. For example, the first sidewall 114 may be an inner sidewall of the hollow 113 that the sealing cap 150 enters. As an example, the first sidewall 114 may extend at a first slope forming a first inclination angle θ1 with the first direction (X+) in which the support portion 110 extends, as illustrated in FIG. 5A. A second sidewall 154 of the sealing cap 150, which will be described later, may be arranged to face the first sidewall 114 and may be supported by the first sidewall 114. As an example, the support portion 110 may include a rigid material, for example, a metal material, which supports the elastic sealing cap 150 so as to be deformable.

In addition, the support portion 110 according to an example may include a first fastening portion 115 that may be fastened to the pipe connection portion 170, which will be described later. As an example, the first fastening portion 115 may be arranged on the inner sidewall of the hollow 113 that the pipe connection portion 170 enters. Accordingly, the sealing cap 150 and the pipe connection portion 170 may be arranged to be sequentially inserted into the hollow 113 of the support portion 110. According to an example, the support portion 110 may be implemented as a nut including a thread in the first fastening portion 115. When the support portion 110 is implemented as a nut and the pipe connection portion 170 is implemented as a nipple that may be fastened to the nut, a second fastening portion 175 arranged on one side of the pipe connection portion 170 is mutually fastened to the first fastening portion 115 provided on the support portion 110, and thus, the pipe connection portion 170 may move in the first direction (X+) with respect to the support portion 110.

The sealing cap 150 may include a gas injection passage through which a gas injection needle N passes so as to supply gas. In addition, the sealing cap 150 according to an example is a sealing member arranged to prevent and/or reduce the supplied gas from leaking. As an example, the sealing cap 150 may be provided in a conduit shape extending in the first direction (X+) such that the gas injection needle N passes therethrough. In addition, the sealing cap 150 may include an elastic material that is deformable according to external pressure so as to prevent and/or reduce the supplied gas from leaking.

One end portion 151 of the sealing cap 150 according to an example may be arranged to be connected to one end portion 171 of the pipe connection portion 170. In addition, the other end portion 152 of the sealing cap 150 may be arranged to pass through the hollow 113 of the support portion 110 such that the gas injection needle N passes therethrough. Accordingly, as illustrated in FIG. 4B, the gas injection needle N that enters the other end portion 152 of the sealing cap 150 enters one end portion 171 of the pipe connection portion 170 through one end portion 151 of the sealing cap 150, and thus, may supply gas to the gas pipe L connected to the pipe connection portion 170. One end portion 151 of the sealing cap 150 and the other end portion 152 of the sealing cap 150 may each be provided in a conduit shape extending in the first direction (X+).

The sealing cap 150 according to an example may include a sealing portion 153 arranged between one end portion 151 and the other end portion 152 thereof. As an example, the sealing portion 153 may block a gap between one end portion 151 and the other end portion 152 each having a conduit shape extending in the first direction (X+). For example, the sealing portion 153 may be a blocking member that extends to have a certain length in the first direction (X+) and blocks a gap between one end portion 151 and the other end portion 152. As an example, the sealing portion 153 may include an elastic material that may be compressed or expanded according to external pressure. As the sealing portion 153 is arranged between one end portion 151 and the other end portion 152, supply gas supplied at high pressure may be blocked from being discharged from the pipe connection portion 170 to the outside.

However, as described above, in order to supply gas to the gas pipe L connected to the pipe connection portion 170, the gas injection needle N may enter through the other end portion 152, the sealing portion 153, and the one end portion 151 of the sealing cap 150. A hole may be formed in the sealing portion 153, which is deformable according to external pressure, by the gas injection needle N. When gas supply to the gas pipe L is completed and the gas injection needle N is removed from the sealing cap 150, the hole that is formed in the sealing cap 150 in the process of entering the gas injection needle N may be naturally contracted and sealed by the self-elasticity of the sealing cap 150 including an elastic material. However, when the gas supplied to the gas pipe L is at a high pressure or when a shock is applied to the outside, there is a risk that the naturally contracted hole may be deformed due to the self-elasticity of the sealing cap 150 and the supplied gas may leak.

According to an example, the sealing cap 150 may include the second sidewall 154 extending at a second slope. For example, the second sidewall 154 may be an outer sidewall of the sealing cap 150 that enters the hollow 113 of the support portion 110 and is arranged to face the first sidewall 114. As an example, the second sidewall 154 may extend at a second slope forming a second inclination angle θ2 with the first direction (X+) in which the sealing cap 150 extends, as illustrated in FIG. 5A. As an example, the first inclination angle θ₁ formed by the first direction (X+) and the first sidewall 114 may be greater than the second inclination angle θ₂ formed by the first direction (X+) and the second sidewall 154. For example, θ₁-θ₂, which is a difference between the first inclination angle θ₁ and the second inclination angle θ₂, may be greater than 0° and less than or equal to 15°.

As an example, as described above, the second sidewall 154 of the sealing cap 150 may be arranged to face the first sidewall 114, and thus, the second sidewall 154 may be supported by the first sidewall 114. According to an example, when the support portion 110 is implemented as a nut and the pipe connection portion 170 is implemented as a nipple that may be fastened to the nut, the second fastening portion 175 arranged on one side of the pipe connection portion 170 is mutually fastened to the first fastening portion 115 provided on the support portion 110, and thus, the pipe connection portion 170 may move in the first direction (X+) with respect to the support portion 110. When the pipe connection portion 170 moves in the first direction (X+) with respect to the support portion 110, the sealing cap 150 may be compressed between the support portion 110 and the pipe connection portion 170. Due to the contact between the first sidewall 114 having the first inclination angle θ₁ and the second sidewall 154 having the second inclination angle θ₂, the sealing cap 150 may be compressed between the support portion 110 and the pipe connection portion 170. As an example, as illustrated in FIG. 5B, the sealing cap 150 may be deformed between the support portion 110 and the pipe connection portion 170 by receiving pressure in a direction (X−) opposite to the first direction (X+) with respect to the support portion 110. Because the sealing cap 150 is arranged between the support portion 110 and the pipe connection portion 170, the range of deformation in the direction (X−) opposite to the first direction (X+) may be limited between the support portion 110 and the pipe connection portion 170. Accordingly, the sealing cap 150 may be compressed in a second direction (Z+, Z−) perpendicular to the first direction (X+). For example, the sealing portion 153 included in the sealing cap 150 may be compressed in the second direction (Z+, Z−) perpendicular to the first direction (X+). Accordingly, the hole that is formed in the sealing portion 153 by the gas injection needle N may be blocked by not only the naturally contracted deformation caused by the self-elasticity of the sealing cap 150 but also additional contracted deformation caused by pressure applied in the second direction (Z+, Z−). Accordingly, even when gas supplied to the gas pipe L is at a high pressure or when a shock is applied to the outside, the hole of the sealing cap 150 may be deformed, and thus, the supplied gas may be prevented and/or reduced from leaking.

The pipe connection portion 170 includes a connecting member that is arranged between the sealing cap 150 and the gas pipe (see L of FIG. 1) and connects the sealing cap 150 to the gas pipe L. The pipe connection portion 170 according to an example may include a conduit shape having a through-hole 173 extending in the first direction (X+). As an example, the through-hole 173 may be provided in a penetrating shape starting from one end portion 171 of the pipe connection portion 170 and extending up to the other end portion 172 thereof. According to an example, one end portion 171 of the pipe connection portion 170 may be connected to one end portion 151 of the sealing cap 150. The other end portion 172 of the pipe connection portion 170 may be connected to an end portion of the gas pipe L.

The pipe connection portion 170 according to an example may include the second fastening portion 175 that is fastened to the first fastening portion 115 provided on the support portion 110. As an example, the second fastening portion 175 may be arranged on one side outside the pipe connection portion 170 so as to be fastened to the first fastening portion 115. According to an example, when the support portion 110 is implemented as a nut including a thread in the first fastening portion 115, the pipe connection portion 170 may be implemented as a nipple including the second fastening portion 175 that may be fastened to the nut. For example, when the first fastening portion 115 and the second fastening portion 175 are fastened to each other, the pipe connection portion 170 may move in the first direction (X+) with respect to the support portion 110. However, the present disclosure is not limited thereto, and the pipe connection portion 170 may be provided in any structure that is fastened to the support portion 110 and is movable in the first direction (X+) with respect to the support portion 110.

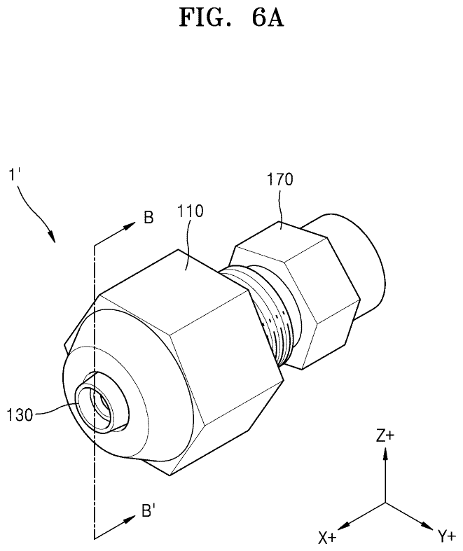

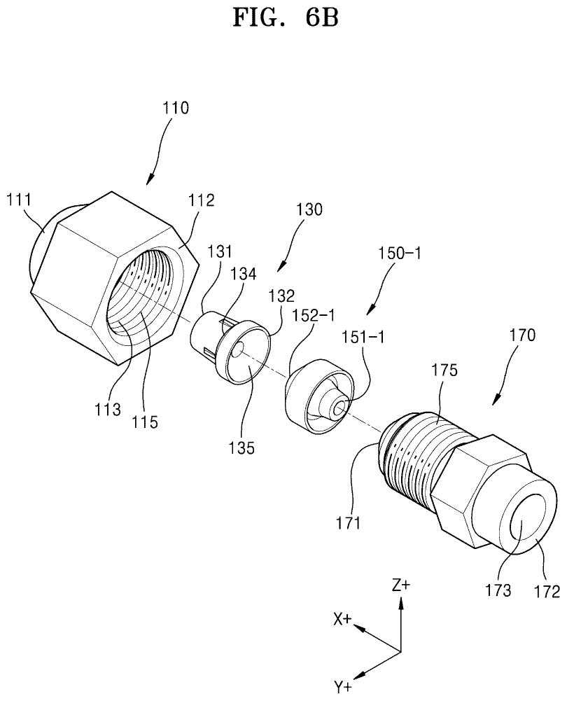

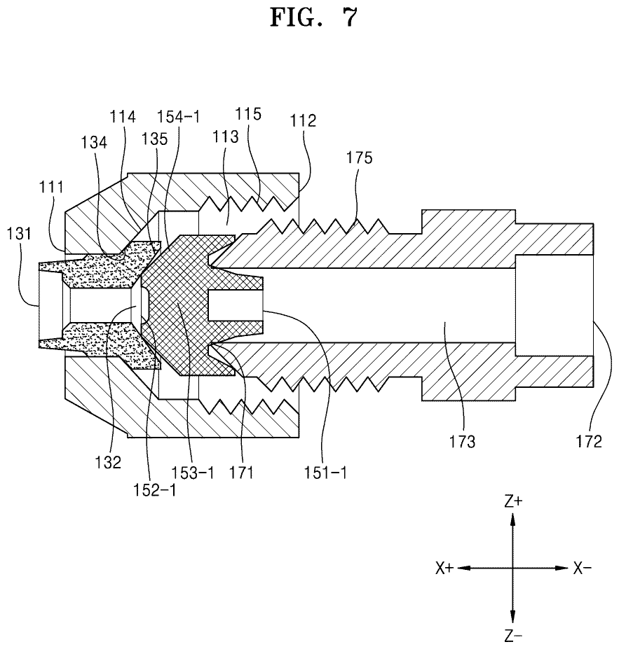

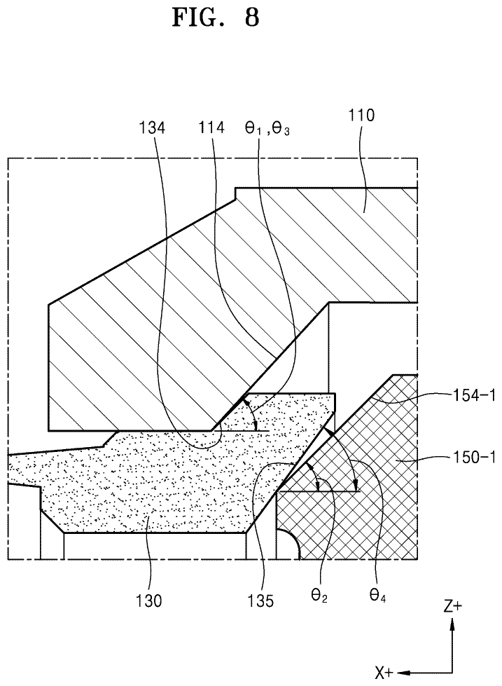

FIG. 6A is a perspective view illustrating an example gas supply device according to various embodiments. FIG. 6B is an exploded perspective view of the gas supply device illustrated in FIG. 6A according to various embodiments. FIG. 7 is a cross-sectional view of the gas supply device illustrated in FIG. 6A taken along line B-B′ according to various embodiments. FIG. 8 is an enlarged cross-sectional view of a portion illustrated in FIG. 7 according to various embodiments.

In the example described above, because the sealing cap 150 including an elastic material is directly supported by the support portion 110, the sealing cap 150 may be torn or unintentionally deformed. In order to prevent and/or reduce unintentional deformation of the sealing cap 150, a support cap 130 may be separately arranged between the support portion 110 and the sealing cap 150. Because the configurations related to the support portion 110 and the pipe connection portion 170, excluding the support cap 130 and the sealing cap 150, are substantially the same as the configurations illustrated in FIGS. 2 to 4B, descriptions of the same configurations may not be repeated here.

Referring to FIGS. 6A, 6B, 7 and 8 (which may be referred to as FIGS. 6A to 8), a gas supply device 1′ according to another example may include a support portion 110, a support cap 130 supported by the support portion 110, a sealing cap 150-1 arranged to prevent and/or reduce supplied gas from leaking, and a pipe connection portion 170 having one end portion connected to the sealing cap 150-1 and the other end portion 172 connected to the gas pipe (see L of FIG. 1).

The support cap 130 may be arranged between the support portion 110 and the sealing cap 150-1 and support the sealing cap 150-1. In addition, the support cap 130 may guide a movement path of a gas injection needle N. As an example, the support cap 130 may include a material that is different from a material of the support portion 110 including a metal material, so as to prevent and/or reduce the sealing cap 150-1 from being torn or excessively damaged during a compression process. For example, the support cap 130 may include a plastic material such as polypropylene. Accordingly, the support cap 130 may support the sealing cap 150-1 and may prevent and/or reduce excessive damage from occurring due to friction with the support cap 130 in the process in which the sealing cap 150-1 is deformed. In addition, the support cap 130 may be provided in a conduit shape extending in the first direction (X+) so as to guide the movement path of the gas injection needle N.

One end portion 131 of the support cap 130 according to an example may be arranged to pass through a hollow 113 of the support portion 110 such that the gas injection needle N passes therethrough. The other end portion 132 of the support cap 130 may be arranged to be connected to the other end portion 152-1 of the sealing cap 150-1. One end portion 151-1 of the sealing cap 150-1 may be connected to one end portion 171 of the pipe connection portion 170. Accordingly, the gas injection needle N that enters one end portion 131 of the support cap 130 enters one end portion 171 of the pipe connection portion 170 through the other end portion 152-1 of the sealing cap 150-1, and thus, may supply gas to the gas pipe L connected to the pipe connection portion 170.

The sealing cap 150-1 according to an example may include a sealing portion 153-1 arranged between one end portion 151-1 and the other end portion 152-1 thereof. As an example, the sealing portion 153-1 may block a gap between one end portion 151-1 and the other end portion 152-1 each having a conduit shape extending in the first direction (X+). Because matters related to the sealing portion 153-1 of the present embodiment are substantially the same as matters related to the sealing portion 153 illustrated in FIGS. 2 to 5B, descriptions thereof are omitted herein.

According to an example, the support cap 130 may include a third sidewall 134 extending at a third slope. For example, the third sidewall 134 may be an outer sidewall of the support cap 130 that enters the hollow 113 of the support portion 110 and is arranged to face the first sidewall 114. As an example, the third sidewall 134 may extend at a third slope forming a third inclination angle θ₃ with the first direction (X+) in which the support cap 130 extends. As an example, the first inclination angle θ₁ formed by the first direction (X+) and the first sidewall 114 may be substantially the same as the third inclination angle θ₃ formed by the first direction (X+) and the third sidewall 134. For example, the first sidewall 114 and the third sidewall 134 may be provided in shapes that correspond to each other. Accordingly, the support cap 130 may be supported by the support portion 110 without receiving unnecessary pressure.

In addition, according to an example, the support cap 130 may include a fourth sidewall 135 extending at a fourth slope. For example, the fourth sidewall 135 may be an inner sidewall arranged to face the second sidewall 154-1, which is the outer sidewall of the sealing cap 150-1. As an example, the fourth sidewall 135 may extend at a fourth slope forming a fourth inclination angle θ₄ with the first direction (X+) in which the support cap 130 extends. As an example, the fourth inclination angle θ₄ formed by the first direction (X+) and the fourth sidewall 135 may be greater than the second inclination angle θ₂ formed by the first direction (X+) and the second sidewall 154-1. For example, a difference between the fourth inclination angle θ₄ and the second inclination angle θ₂ may be greater than 0° and less than or equal to 15°.

As an example, as described above, the second sidewall 154-1 of the sealing cap 150-1 may be arranged to face the fourth sidewall 135, and thus, the second sidewall 154-1 may be supported by the fourth sidewall 135. According to an example, when the support portion 110 is implemented as a nut and the pipe connection portion 170 is implemented as a nipple that may be fastened to the nut, the second fastening portion 175 arranged on one side of the pipe connection portion 170 is mutually fastened to the first fastening portion 115 provided on the support portion 110, and thus, the pipe connection portion 170 may move in the first direction (X+) with respect to the support portion 110. When the pipe connection portion 170 moves in the first direction (X+) with respect to the support portion 110, the sealing cap 150-1 may be compressed between the support cap 130 and the pipe connection portion 170. Due to the contact between the fourth sidewall 135 having the fourth inclination angle θ₄ and the second sidewall 154-1 having the second inclination angle θ₂, the sealing cap 150-1 may be compressed between the support cap 130 and the pipe connection portion 170.

As an example, the sealing cap 150-1 may be deformed between the support cap 130 and the pipe connection portion 170 by receiving pressure in a direction (X−) opposite to the first direction (X+) with respect to the support cap 130. Because the sealing cap 150-1 is arranged between the support cap 130 and the pipe connection portion 170, the range of deformation in the direction (X−) opposite to the first direction (X+) may be limited between the support cap 130 and the pipe connection portion 170. Accordingly, the sealing cap 150-1 may be compressed in a second direction (Z+, Z−) perpendicular to the first direction (X+). For example, the sealing portion 153-1 included in the sealing cap 150-1 may be compressed in the second direction (Z+, Z−) perpendicular to the first direction (X+). Accordingly, the hole that is formed in the sealing portion 153-1 by the gas injection needle N may be blocked by not only the naturally contracted deformation caused by the self-elasticity of the sealing cap 150-1 but also additional contracted deformation caused by pressure applied in the second direction (Z+, Z−). Accordingly, even when gas supplied to the gas pipe L is at a high pressure or when a shock is applied to the outside, the hole of the sealing cap 150-1 may be deformed, and thus, the supplied gas may be prevented and/or reduced from leaking.

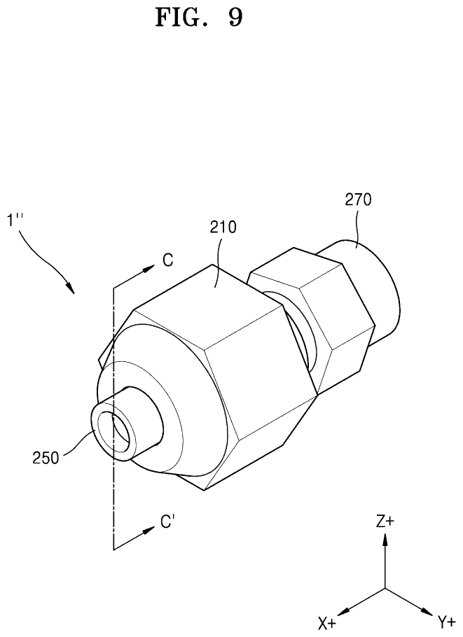

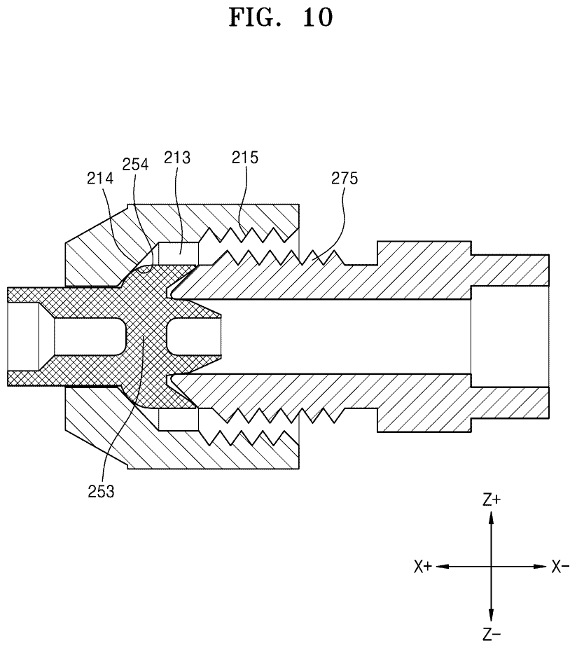

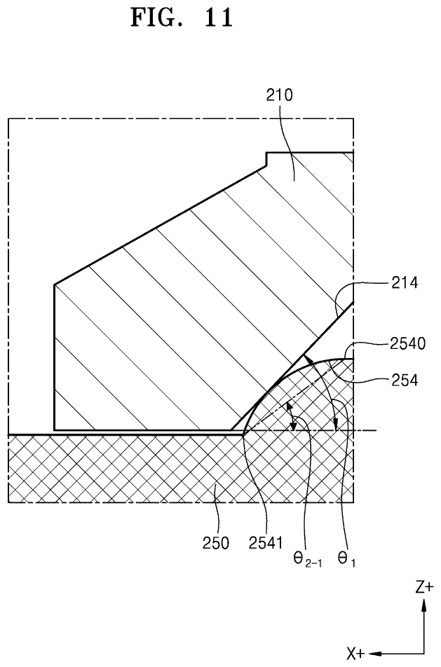

FIG. 9 is a perspective illustrating an example gas supply device according to various embodiments. FIG. 10 is a cross-sectional view of the gas supply device illustrated in FIG. 9 taken along line C-C′ according to various embodiments. FIG. 11 is an enlarged cross-sectional view of a portion illustrated in FIG. 10 according to various embodiments.

Referring to FIGS. 9, 10 and 11 (which may be referred to as FIGS. 9 to 11), a gas injection device 1″ according to another example may include a support portion 210, and a pipe connection portion 270 having one end portion connected to a sealing cap 250 and the other end portion connected to the gas pipe (see L of FIG. 1). The configurations related to the support portion 210, the sealing cap 250, and the pipe connection portion 270 are substantially the same as the configurations related to the support portion 110, the sealing cap 150, and the pipe connection portion 170 illustrated in FIGS. 2 to 4B, except for the feature that a second sidewall 254 of the sealing cap 250 is formed as a curved surface extending to have a certain curvature in the first direction (X+). Accordingly, descriptions of the same configurations may not be repeated here.

According to an example, the sealing cap 250 may include a second sidewall 254 having a curved shape extending with a certain curvature. For example, the second sidewall 254 may be an outer sidewall of the sealing cap 250 that enters a hollow 213 of the support portion 210 and is arranged to face a first sidewall 214. As an example, as illustrated in FIG. 11, the second sidewall 254 may extend in the first direction (X+) to have a certain curvature between a first point 2540 at which the curved surface starts and a second point 2541 at which the curved surface ends. An inclined surface extending in a straight line between the first point 2540 and the second point 2541 may have a second−1 inclination angle θ₂₋₁ with respect to a first direction (X+). As an example, a first inclination angle θ₁ formed by the first direction (X+) and the first sidewall 214 may be greater than the second−1 inclination angle θ₂₋₁. For example, θ₁-θ₂₋₁, which is a difference between the first inclination angle θ₁ and the second−1 inclination angle θ₂, may be greater than 0° and less than or equal to 15°.

As an example, as described above, the second sidewall 254 of the sealing cap 250 may be arranged to face the first sidewall 214, and thus, the second sidewall 254 may be supported by the first sidewall 214. According to an example, when the support portion 210 is implemented as a nut and the pipe connection portion 270 is implemented as a nipple that may be fastened to the nut, the second fastening portion 275 arranged on one side of the pipe connection portion 270 is mutually fastened to the first fastening portion 215 provided on the support portion 210, and thus, the pipe connection portion 270 may move in the first direction (X+) with respect to the support portion 210. When the pipe connection portion 270 moves in the first direction (X+) with respect to the support portion 210, the sealing cap 250 may be compressed between the support portion 210 and the pipe connection portion 270. Due to the contact between the first sidewall 214 and the second sidewall 254, the sealing cap 250 may be compressed between the support portion 210 and the pipe connection portion 270. As an example, the sealing cap 250 may be deformed between the support portion 210 and the pipe connection portion 270 by receiving pressure in a direction (X−) opposite to the first direction (X+) with respect to the support portion 210. Because the sealing cap 250 is arranged between the support portion 210 and the pipe connection portion 270, the range of deformation in the direction (X−) opposite to the first direction (X+) may be limited between the support portion 210 and the pipe connection portion 270. Accordingly, the sealing cap 250 may be compressed in a second direction (Z+, Z−) perpendicular to the first direction (X+). For example, the sealing portion 253 included in the sealing cap 250 may be compressed in the second direction (Z+, Z−) perpendicular to the first direction (X+). Accordingly, the hole formed in the sealing portion 253 by the gas injection needle N may be blocked by not only the naturally contracted deformation caused by the self-elasticity of the sealing cap 250 but also additional contracted deformation caused by pressure applied in the second direction (Z+, Z−). Accordingly, even when gas supplied to the gas pipe L is at a high pressure or when a shock is applied to the outside, the hole of the sealing cap 250 may be deformed, and thus, the supplied gas may be prevented and/or reduce from leaking.

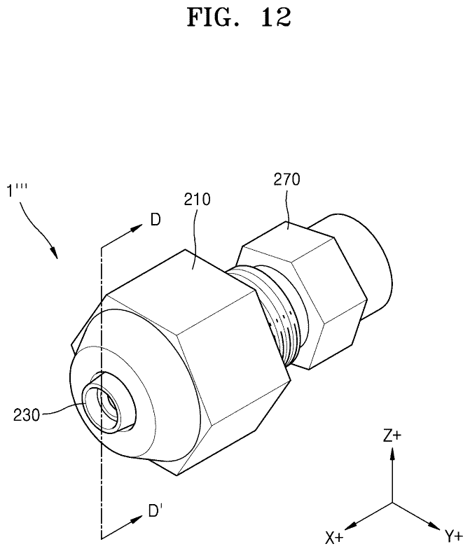

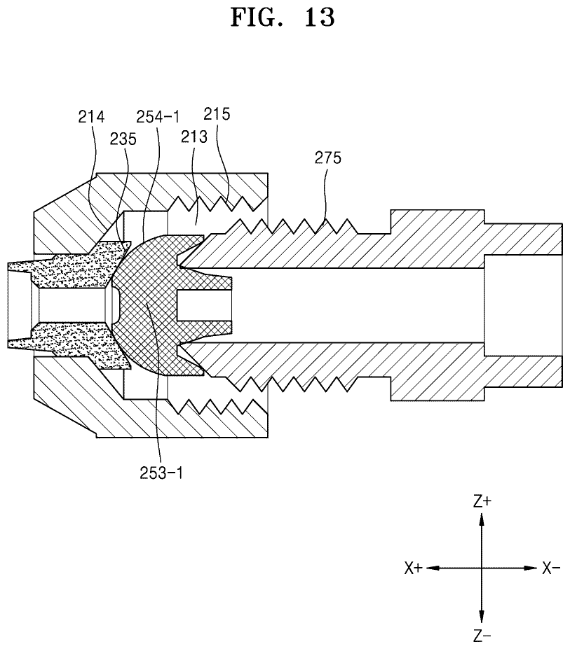

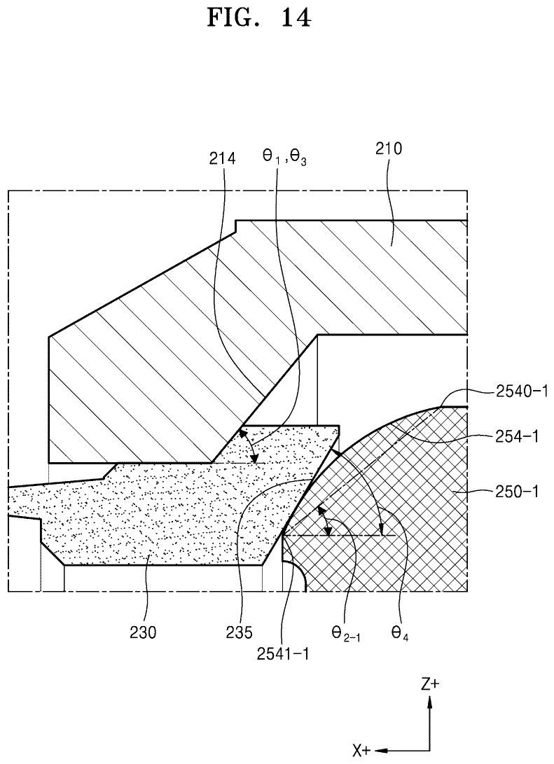

FIG. 12 is a perspective view illustrating an example gas supply device according to various embodiments. FIG. 13 is a cross-sectional view of the gas supply device illustrated in FIG. 12 taken along line D-D′ according to various embodiments. FIG. 14 is an enlarged cross-sectional view of a portion illustrated in FIG. 13 according to various embodiments.

Referring to FIGS. 12, 13 and 14 (which may be referred to as FIGS. 12 to 14), a gas injection device 1″ according to an example may include a support portion 210, a support cap 230 supported by the support portion 210, and a pipe connection portion 270 having one end portion connected to a sealing cap 250-1 and the other end portion connected to the gas pipe (see L of FIG. 1). The configurations related to the support portion 210, the support cap 230, the sealing cap 250-1, and the pipe connection portion 270 are substantially the same as the configurations related to the support portion 110, the support cap 130, the sealing cap 150-1, and the pipe connection portion 170 illustrated in FIGS. 6A to 8, except for the feature that a second sidewall 254-1 of the sealing cap 250-1 is formed as a curved surface extending to have a certain curvature in the first direction (X+). Accordingly, descriptions of the same configurations may not be repeated here.

In addition, according to an example, the support cap 230 may include a fourth sidewall 235 extending at a fourth slope. For example, the fourth sidewall 235 may be an inner sidewall arranged to face the second sidewall 254-1, which is the outer sidewall of the sealing cap 250-1. As an example, as illustrated in FIG. 14, the fourth sidewall 235 may extend at a fourth slope forming a fourth inclination angle θ₄ with the first direction (X+) in which the support cap 230 extends. The second sidewall 254-1 may extend in the first direction (X+) to have a certain curvature between a first point 2540-1 at which the curved surface starts and a second point 2541-1 at which the curved surface ends. An inclined surface extending in a straight line between the first point 2540-1 and the second point 2541-1 may have a second−1 inclination angle θ₂₋₁ with respect to the first direction (X+). As an example, a first inclination angle θ₁ formed by the first direction (X+) and the first sidewall 214 may be greater than the second−1 inclination angle θ₂₋₁. For example, θ₁-θ₂₋₁, which is a difference between the first inclination angle θ₁ and the second−1 inclination angle θ₂, may be greater than 0° and less than or equal to 15°.

As an example, as described above, the second sidewall 254-1 of the sealing cap 250-1 may be arranged to face the fourth sidewall 235, and thus, the second sidewall 254-1 may be supported by the fourth sidewall 235. According to an example, when the support portion 210 is implemented as a nut and the pipe connection portion 270 is implemented as a nipple that may be fastened to the nut, the second fastening portion 275 arranged on one side of the pipe connection portion 270 is mutually fastened to the first fastening portion 215 provided on the support portion 210, and thus, the pipe connection portion 270 may move in the first direction (X+) with respect to the support portion 210. When the pipe connection portion 270 moves in the first direction (X+) with respect to the support portion 210, the sealing cap 250-1 may be compressed between the support cap 230 and the pipe connection portion 270. Due to the contact between the fourth sidewall 235 and the second sidewall 254-1, the sealing cap 250-1 may be compressed between the support cap 230 and the pipe connection portion 270.

As an example, the sealing cap 250-1 may be deformed between the support cap 130 and the pipe connection portion 270 by receiving pressure in a direction (X−) opposite to the first direction (X+) with respect to the support cap 230. Because the sealing cap 250-1 is arranged between the support cap 230 and the pipe connection portion 270, the range of deformation in the direction (X−) opposite to the first direction (X+) may be limited between the support cap 230 and the pipe connection portion 270. Accordingly, the sealing cap 250-1 may be compressed in a second direction (Z+, Z−) perpendicular to the first direction (X+). For example, a sealing portion 253-1 included in the sealing cap 250-1 may be compressed in the second direction (Z+, Z−) perpendicular to the first direction (X+). Accordingly, the hole that is formed in the sealing portion 253-1 by the gas injection needle N may be blocked by not only the naturally contracted deformation caused by the self-elasticity of the sealing cap 250-1 but also additional contracted deformation caused by pressure applied in the second direction (Z+, Z−). Accordingly, even when gas supplied to the gas pipe L is at a high pressure or when a shock is applied to the outside, the hole of the sealing cap 250-1 may be deformed, and thus, the supplied gas may be prevented and/or reduce from leaking.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A gas injection device comprising:
a support portion including a support having a first sidewall extending at a first slope;
a sealing cap comprising an elastic material and having a second sidewall extending at a second slope; and
a pipe connection portion including a conduit shape having a through-hole extending in a first direction, the pipe connection portion having one end portion connected to one end portion of the sealing cap,
wherein the first sidewall and the second sidewall are arranged to face each other, and a first inclination angle formed by the first direction and the first sidewall is greater than a second inclination angle formed by the first direction and the second sidewall.

2. The gas injection device of claim 1, wherein the support portion includes a nut, and the pipe connection portion includes a nipple having one side capable of being fastened to the nut.

3. The gas injection device of claim 2, wherein, based on the support portion and the pipe connection portion being fastened to each other and the pipe connection portion moving in the first direction with respect to the support portion, the sealing cap is compressed between the support portion and the pipe connection portion.

4. The gas injection device of claim 1, wherein the support portion includes a hollow extending in the first direction, and the other end portion of the sealing cap is configured to pass through the hollow.

5. The gas injection device of claim 1, further comprising a support cap arranged between the support portion and the sealing cap.

6. The gas injection device of claim 5, wherein the support cap comprises:
a third sidewall arranged to face the first sidewall and extending at a third slope; and
a fourth sidewall arranged to face the second sidewall and extending at a fourth slope.

7. The gas injection device of claim 6, wherein a first inclination angle formed by the first direction and the first sidewall is equal to a third inclination angle formed by the first direction and the third sidewall, and
a fourth inclination angle formed by the first direction and the fourth sidewall is greater than a second inclination angle formed by the first direction and the second sidewall.

8. The gas injection device of claim 5, wherein the support portion includes a hollow extending in the first direction, and one end portion of the support cap is configured to pass through the hollow.

9. A gas injection device comprising:
a support portion including a first sidewall having a curved shape extending with a first curvature;
a sealing cap comprising an elastic material and having a second sidewall of a curved shape extending with a second slope; and
a pipe connection portion having a conduit shape and including a through-hole extending in a first direction, the pipe connection portion having one end portion connected to one end portion of the sealing cap,
wherein the first sidewall and the second sidewall are arranged to face each other, the first sidewall extending to have a first inclination angle with the first direction, the second sidewall having a curved surface extending to have a certain curvature in the first direction, and
an inclined surface extending in a straight line between a first point at which the curved surface starts and a second point at which the curved surface ends has a second-first inclination angle with the first direction, the first inclination angle being greater than the second-first inclination angle.

10. The gas injection device of claim 9, wherein the support portion includes a nut, and the pipe connection portion includes a nipple having one side capable of being fastened to the nut.

11. The gas injection device of claim 10, wherein, based on the support portion and the pipe connection portion being fastened to each other and the pipe connection portion moving in the first direction with respect to the support portion, the sealing cap is compressed with respect to the support portion.

12. The gas injection device of claim 9, wherein the support portion includes a hollow extending in the first direction, and the other end portion of the sealing cap passes through the hollow.

13. The gas injection device of claim 9, further comprising a support cap arranged between the support portion and the sealing cap.

14. The gas injection device of claim 13, wherein the support cap comprises:
a third sidewall arranged to face the first sidewall and extending at a third slope; and
a fourth sidewall arranged to face the second sidewall and extending at a fourth slope.

15. The gas injection device of claim 14, wherein the first inclination angle formed by the first direction and the first sidewall is equal to a third inclination angle formed by the first direction and the third sidewall, and a fourth inclination angle formed by the first direction and the fourth sidewall is greater than the second-first inclination angle formed by the first direction and the second sidewall.
